(19) United States
(12) Patent Application Publication
(10) Pub. No.: US 2011/0110082 A1
(43) Pub. Date: May 12, 2011

(54) Gain Structure For Improving Luminance Of Road Lamp

(76) Inventor: Cheng-Chao Jong, Taoyuan (TW)

(21) Appl. No.: 12/616,143

(22) Filed: Nov. 11, 2009

(51) Int. Cl. F21V 1/00

(52) U.S. Cl. 362/235

(57) ABSTRACT

A gain structure for improving a luminance of a road lamp is disclosed. The gain structure includes a plurality of lamps and a plurality of reflecting shades. The lamps are secured to an end surface of a body of the road lamp. The lamps arranged at an outer side are arranged with an oblique angle toward the lamp arranged at a middle side of the lamps, so that the illumination range can be enlarged. Each of the reflecting shades is provided for accommodating a plurality of light emitting units therein for improving the efficiency of each of the light emitting units. In such a way, the present invention is adapted for providing a solution for the problems of the conventional technology, and is further adapted for improving the entire light emitting efficiency and lowering the glare.

### BACKGROUND OF THE INVENTION

1. Field of the Invention

The present invention relates generally to a gain structure for improving a luminance of a road lamp, and more particularly, to a road lamp having an improved light outputting efficiency and an enlarged illuminating range by controlling an light outputting angle of respective lamp of the road lamp and concentrating the light source with a reflecting shade.

2. The Prior Arts

Currently, in the information technology era, environmental protection has attracted more concern than before. Correspondingly, it is worldwide mission to save the energy consumption and reduce the environment pollution caused thereby. Accordingly, the illumination technology is now developed for energy saving, low pollution, and intelligentization. Therefore, lamps which are more efficient, low glare, low light pollution represent the trend of lamp development.

Referring to FIG. 1, there is shown a conventional LED lamp set 1a. The conventional LED lamp set 1a includes a plurality of LED units 11a. The LED units 11a are arranged on a flat plate shaped base 12a in a same plane. Each of the LED units 11a projects a light, thus achieving the objective of wide angle illumination.

However, since each of the LED units 11a divergently projects the light therefrom, when considered as whole, the LED lamp set 1a utilizes the light of the respective LED unit 11a with a low efficiency, so that the luminance of the LED lamp set 1a is not satisfactory.

### SUMMARY OF THE INVENTION

A primary objective of the present invention is to provide a gain structure for improving a luminance of a road lamp. According to the present invention, illuminating angles of lamp units of the road lamp are controlled, and a reflecting shade is provided, so as to improve the overall light outputting efficiency and enlarge the illumination range.

For achieving the foregoing objective and others, the present invention provides a gain structure for improving a luminance of a road lamp. The gain structure includes a plurality of lamps. Each of the lamps includes a socket, and a plurality of light emitting units. The socket includes a connection portion at one end of the socket. The connection portion of the socket is adapted for being locked to an end surface of a body of the road lamp for securing the socket to the body of the road lamp. The socket includes a plurality of inwardly recessed slots and a plurality of light emitting units. Each slot has a light outputting surface, on which one of the light emitting units is disposed. Each slot includes two fixing portions configured at two sidewalls corresponding to the light emitting unit, respectively. The lamps are side by side arranged, in which lamps arranged at an outer side are arranged with an oblique angle toward the lamp arranged at a middle side of the lamps. The gain structure further includes a plurality of reflecting shades. Each of the reflecting shades is correspondingly provided to one of the light emitting units. The reflecting shade is bell jar shaped and includes an upper reflecting plane, and a lower reflecting plane. Both of the upper reflecting plane and the lower reflecting plane are constituted of a plurality of plane units. The reflecting shade is configured with an opening portion at a center of a top side of the reflecting shade. The reflecting shade further includes two fixing members configured at two opposite outer sides of the reflecting shade. The two fixing members are correspondingly provided for being fixed to the two fixing portions by screw members. The opening portion is adapted for being closely attached to a periphery of the light emitting unit, and accommodating the light emitting unit inside the reflecting shade therefrom.

In such a way, the present invention is adapted for providing a solution for the problems of the conventional technology as discussed above, and is further adapted for improving the entire light emitting efficiency and lowering the glare.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating a conventional LED lamp set;

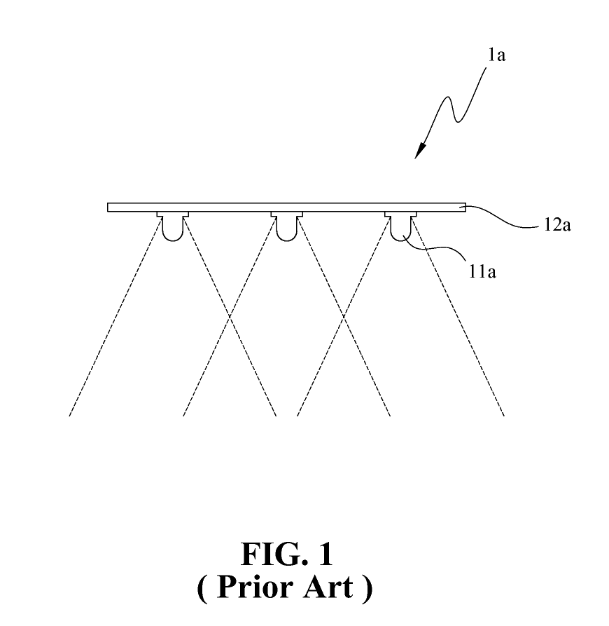

FIG. 2 is a schematic diagram illustrating lamps of a gain structure of a road lamp according to an embodiment of the present invention;

FIG. 3 is a schematic diagram illustrating a reflecting shade of the gain structure according to an embodiment of the present invention;

FIG. 4 illustrates the assembled condition of the gain structure; and

FIG. 5 is a schematic diagram illustrating the operation condition of the road lamp.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

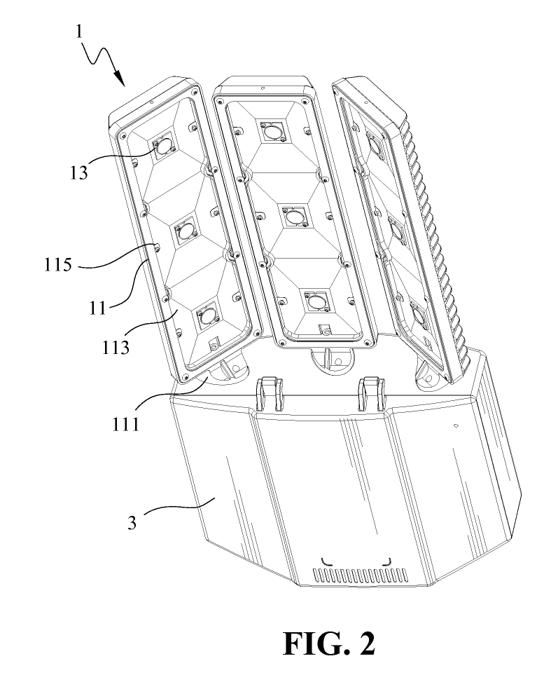

FIG. 2 is a schematic diagram illustrating lamps of a gain structure of a road lamp according to an embodiment of the present invention. Referring to FIG. 2, the present invention provides a gain structure for improving a luminance of a road lamp. The gain structure includes a plurality of lamps 1. Each of the lamps 1 includes a socket 11, and a plurality of light emitting units 13. The socket 11 includes a connection portion 111 at one end of the socket 11. The connection portion 111 of the socket 11 is adapted for being locked to an end surface of a body 3 of the road lamp for securing the socket 11 to the body 3 of the road lamp. The socket 11 includes a plurality of inwardly recessed slots 113 and a plurality of light emitting units 13. Each slot 113 has a light outputting surface, on which one of the light emitting units 13 is disposed. Each slot 113 includes two fixing portions 115 configured at two sidewalls of the slot 113 corresponding to the light emitting unit 13, respectively. The lamps 1 are side by side arranged, in which lamps 1 arranged at an outer side are arranged with an oblique angle toward the lamp 1 arranged at a middle side of the lamps 1.

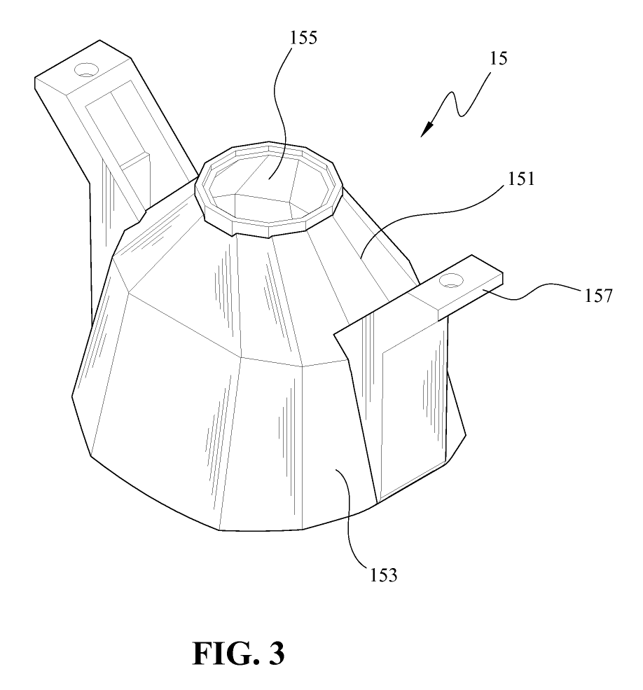

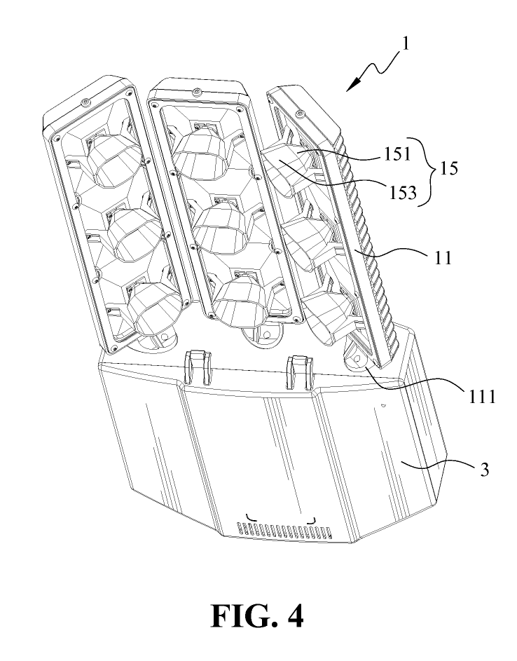

FIG. 3 is a schematic diagram illustrating a reflecting shade of the gain structure according to an embodiment of the present invention. FIG. 4 illustrates the assembled condition of the gain structure. Referring to FIGS. 3 and 4 together, the gain structure further includes a plurality of reflecting shades 15. Each of the reflecting shades 15 is correspondingly provided to one of the light emitting units 13. The reflecting shade 15 is bell jar shaped and includes an upper reflecting plane 151, and a lower reflecting plane 153. Both of the upper reflecting plane 151 and the lower reflecting plane 153 are constituted of a plurality of plane units. The inner wall of the reflecting shade 15 is configured with a mirror finish. The reflecting shade 15 is configured with an opening portion 155 at a center of a top side of the reflecting shade 15. The opening portion 155 has a diameter at least greater than a size of the light emitting unit 13, so that the opening portion 155 can be closely attached to a periphery of the light emitting unit 13 so as to accommodate the light emitting unit 13 inside the reflecting shade 15 therefrom. The reflecting shade 15 further includes two fixing members 157 configured at two opposite outer sides of the reflecting shade 15. The two fixing members 157 are correspondingly provided for being fixed to the two fixing portions 115 by screw members (not shown in the drawings).

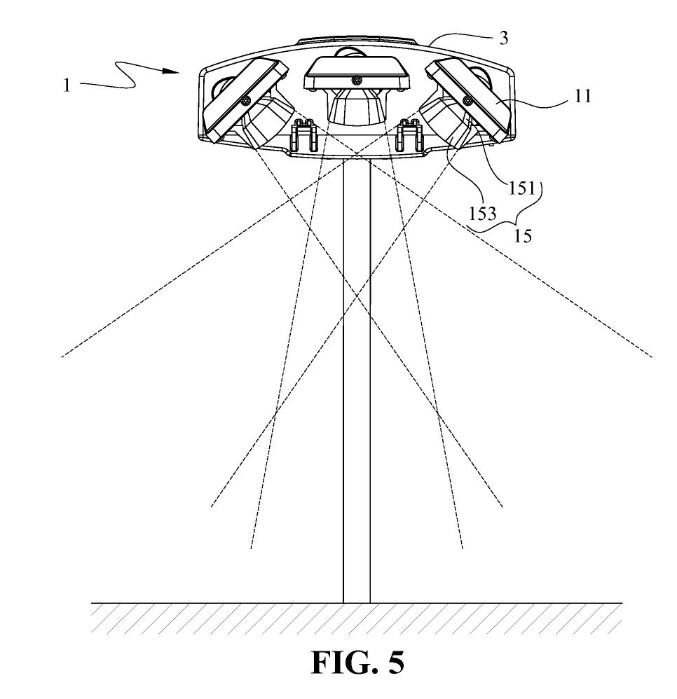

FIG. 5 is a schematic diagram illustrating the operation condition of the road lamp. Referring to FIG. 5, a gain structure of a road lamp as shown in FIG. 5 includes three lamps 1 arranged side by side. The three lamps 1 are secured to the end surface of the body 3 of the road lamp by the connection portions 111 thereof, respectively. The lamps 1 arranged at the left side and the right side are arranged with an oblique angle toward the lamp 1 arranged in the middle. In such a way, the three lamps are adapted for projecting lights in a convergent manner. When the light emitting units 13 output lights, the lights are reflected by the upper reflecting plane 151 and the lower reflecting plane 153 of the reflecting shade 15 into the ambient space. In accordance with the current embodiment, by controlling the oblique angles of the lamps 1 at the left side and the right side, and facilitated by the reflecting shades 15, the road lamp can obtain an illuminating efficiency of up to 93.9%, as well as an enlarged illumination range.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A gain structure for improving a luminance of a road lamp, the gain structure comprising:
a plurality of lamps arranged side by side, each of the lamps comprising a socket, and a plurality of light emitting units, wherein the socket comprises a connection portion at one end of the socket, and the connection portion of the socket is adapted for being locked to an end surface of a body of the road lamp for securing the socket to the body of the road lamp, wherein the socket further comprises a plurality of inwardly recessed slots and a plurality of light emitting units, and each of the slots has a light outputting surface, on which one of the light emitting units is disposed, and each slot comprises two fixing portions configured at two sidewalls of the slot corresponding to the light emitting unit, respectively, wherein the lamps positioned apart from a middle side of the lamps are arranged with an oblique angle toward the lamp arranged at the middle side; and
a plurality of bell jar shaped reflecting shades, each of the reflecting shades being correspondingly provided to one of the light emitting units, wherein each of the reflecting shades comprises an upper reflecting plane, and a lower reflecting plane, and both of the upper reflecting plane and the lower reflecting plane are constituted of a plurality of plane units, wherein the reflecting shade is configured with an opening portion at a center of a top side of the reflecting shade, and the reflecting shade comprises two fixing members configured at two opposite outer sides of the reflecting shade respectively, and the two fixing members are correspondingly provided for being fixed to the two fixing portions by screw members, wherein the opening portion is adapted for being closely attached to a periphery of the light emitting unit, and accommodating the light emitting unit inside the reflecting shade therefrom.

2. The gain structure according to claim 1, wherein an inner wall of the reflecting shade is configured with a mirror finish.

3. The gain structure according to claim 1, wherein the opening portion has a diameter greater than a size of the light emitting unit.
